(19) United States
(12) Patent Application Publication
(10) Pub. No.: US 2008/0088428 A1
(43) Pub. Date: Apr. 17, 2008

(54) Dynamic Emergency Notification and Intelligence System

(76) Inventors: Brian Pitre, Canandaigua, NY (US); Daniel Albert, Victor, NY (US)

Correspondence Address: JAECKLE FLEISCHMANN & MUGEL, LLP, 190 Linden Oaks, ROCHESTER, NY, 14625-2812, US

(21) Appl. No.: 11/756,935

(22) Filed: Jun. 1, 2007

Related U.S. Application Data
(63) Continuation-in-part of application No. 11/076,714, filed on Mar. 10, 2005.
(60) Provisional application No. 60/745,040, filed on Jun. 1, 2006.
(60) Provisional application No. 60/745,045, filed on Jun. 1, 2006.

(51) Int. Cl. G08B 29/00

(52) U.S. Cl. 340/506

(57) ABSTRACT

A dynamic emergency notification and intelligence system (DENIS system) is disclosed. The DENIS system has a message server and computing system. The message server is configured to communicate an outgoing message to a plurality of users via one or more user devices. The message server is also configured to receive active confirmation from at least one user of the plurality of users that the outgoing message was received. The computing system is configured to use the active confirmation received by the message server from the at least one user to connect the at least one user to a group communication environment.

### RELATED APPLICATIONS

This application is a continuation-in-part of pending U.S. patent application Ser. No. 11/076,714, filed Mar. 10, 2005 and entitled “Dynamic Emergency Notification and Intelligence System.” U.S. patent application Ser. No. 11/076,714 is hereby incorporated by reference in its entirety.

This application also claims priority to U.S. provisional patent application 60/745,040, filed Jun. 1, 2006 and entitled “Dynamic Emergency Notification and Intelligence System with Voice Communication and Automatic Teleconference.” Provisional U.S. patent application 60/745,040 is hereby incorporated by reference in its entirety.

This application further claims priority to U.S. provisional patent application 60/745,045, filed Jun. 1, 2006 and entitled “Dynamic Emergency Notification and Intelligence System Utilizing a Blog or a Wiki.” Provisional U.S. patent application 60/745,045 is hereby incorporated by reference in its entirety.

### FIELD

The claimed invention relates generally to an improved system for emergency communication, and more particularly to a comprehensive system and methodology enabling rapid bi-directional communication, to multiple recipients using varied communications devices, of relevant and emergency information.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

A variety of threats, including terrorism, school emergencies, impending storms, and natural disasters, in addition to the ensuing actions of city, state, county, school, and government departments have created a need for public and private entities to cooperate in unprecedented ways. Traditionally, emergency response organizations at the local, state, and federal levels, as well as support organizations like hospitals, the Red Cross, and utilities, have trained for, planned for, and responded to events in an independent manner. In an effort to encourage response organizations to communicate and coordinate more effectively, the Homeland Security Presidential Directive 5 (HSPD-5) now mandates that responses must be integrated based on common platforms called the National Incident Management System (NIMS) and the National Response Plan. Unfortunately, current communications systems reflect an independent approach and not the current mandate core commonality.

Another important aspect of preparing for and responding to threats involves being able to effectively communicate with the public. In the past, emergency notification systems have been focused on providing as many people as possible with alerts, for example, an emergency broadcast could be made over a television or radio station. Unfortunately, such alerts, while somewhat helpful, are one-way communications, and do not allow for any type of confirmation that the intended audience has received the alert.

Recently, some companies have disclosed alert notification systems which add an element of confirmation in an effort to close the loop on formerly one-way communications. For example, U.S. Pat. No. 7,130,389 discloses a digital notification and response system which allows an administrator to create a message for distribution to a set of users from a database. The message is simultaneously transmitted through at least two industry standard gateways to a variety of electronic devices (including cell phones, email accounts, pagers, etc) for the designated users. Each user's electronic device then generates and transmits a response to the notification system as confirmation that the device received the alert. While such a system has the potential for mass communication and flexibility to communicate with a variety of devices, the type of confirmation provided-for in such a system is highly passive in nature and does not necessarily indicate that a person has read, heard, processed, and understood the alert which has been sent out. Therefore, it would be highly desirable to have an emergency notification system which not only was capable of mass communication, but also would be capable of active confirmation so that those sending out the alerts could have reliable statistics on how well-received each alert truly was. Furthermore, in order to help meet the goals of HSPD-5 it is also desirable that emergency alert systems move beyond confirmation. Recent events such as the attack on Sep. 11, 2001, hurricane Katrina, and the shootings at Virginia Tech have highlighted the need for tools to help manage crises in real time. It would also be desirable to have a dynamic emergency notification system capable not only of massive and targeted notifications combined with mass-bidirectional active confirmation, but also capable of collecting and coordinating data from users so that the right information is made available to those who need it. It is further desirable that the dynamic emergency notification system has the ability to intelligently connect various users for follow-up communications, briefings, investigations, planning, etc.

### SUMMARY

A dynamic emergency notification and intelligence system (DENIS system) is disclosed. The DENIS system has a message server and computing system. The message server is configured to communicate an outgoing message to a plurality of users via one or more user devices. The message server is also configured to receive active confirmation from at least one user of the plurality of users that the outgoing message was received. The computing system is configured to use the active confirmation received by the message server from the at least one user to connect the at least one user to a group communication environment.

A method of providing and gathering real-time information to and from at least one user is disclosed. An outgoing message is communicated to the at least one user. Active confirmation is received from the at least one user that the outgoing message was received. The at least one user is connected to a group communication environment following receipt of the active confirmation.

A data signal for transmission over a physical media is also disclosed. The data signal comprises emergency information and an active confirmation mechanism.

### BRIEF DESCRIPTION OF THE DRAWINGS

FIG. 1 schematically illustrates one embodiment of a dynamic emergency notification and intelligence system (DENIS).

FIG. 2 illustrates one embodiment of a method of providing and gathering real-time information to and from at least one user.

FIG. 3 schematically illustrates an embodiment of a data signal for transmission over a physical medium.

FIG. 4 schematically illustrates some of the functionality and structure for one embodiment of a DENIS system.

FIG. 5 schematically illustrates one embodiment of a single DENIS node.

FIG. 6 schematically illustrates one embodiment of a multi-node system for a large-scale DENIS system.

FIG. 7 schematically illustrates another embodiment of a multi-node system for a large-scale DENIS system.

FIG. 8 illustrates one embodiment of a DENIS system user interface for managing alerts, lists, reports, and data collection.

FIGS. 9A and 9B illustrate one embodiment of a DENIS system user interface for sending an alert.

FIG. 10 illustrates one embodiment of a DENIS system user interface for editing an HTML version of an alert.

FIG. 11 illustrates one embodiment of a DENIS system user interface for managing user lists.

FIGS. 12A and 12B illustrate another embodiment of a DENIS system user interface for managing user lists.

FIG. 13 illustrates one embodiment of a DENIS system user interface for viewing active confirmation details for an alert.

FIG. 14 illustrates one embodiment of a DENIS system user interface for managing data collection forms.

FIG. 15 illustrates one embodiment of a DENIS system data collection form.

It will be appreciated that for purposes of clarity and where deemed appropriate, reference numerals have been repeated in the figures to indicate corresponding features, and that the various elements in the drawings have not necessarily been drawn to scale in order to better show the features.

### DETAILED DESCRIPTION

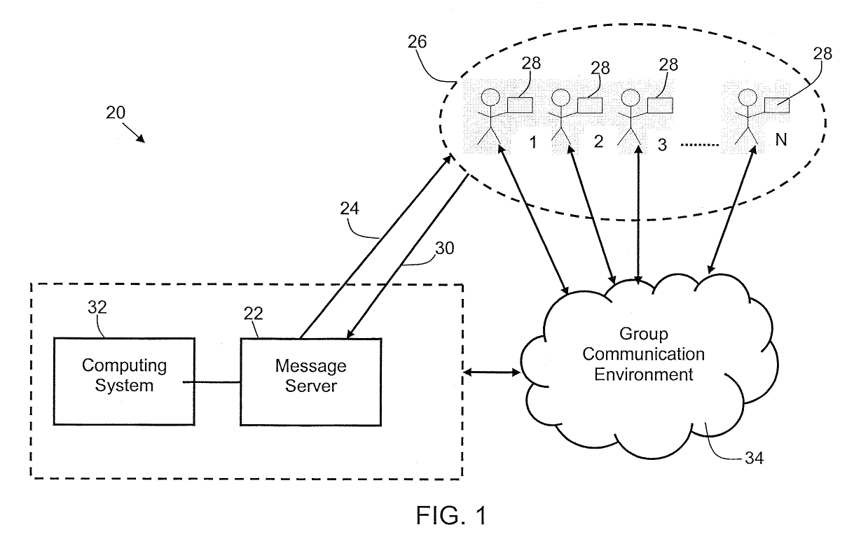

FIG. 1 schematically illustrates one embodiment of a dynamic emergency notification and intelligence system 20 (DENIS). The DENIS system 20 has a message server 22 which is configured to communicate 24 an outgoing message to a plurality of users 26. The message server 22 is capable of communicating using a variety of protocols and/or methods, including, but not limited to email, voicemail, analog voice communication, radio communication, text messaging, digital wireless messaging, voice-over-IP (VoIP), broadcast message, paging, digital voice communication, instant messaging, and fax transmission. Each of the users 26 may have one or more user devices 28 which can include, but is not limited to a computer, a PDA, a mobile phone, a Blackberry® device, a pager, a telephone, a fax machine, a 911 call center, an application protocol interface (API), or any combination or plurality thereof. The DENIS system 20 may be configured by the user and/or an administrator to specify one or more communication device 28 for each user 26 and the associated routing information, such as email address, phone number, IP address, pager number, user ID, etc. The DENIS system 20 may also be configured to handle multiple contact devices 28 for each user with a user or administrator selectable priority as to what order the devices are communicated-with. The DENIS system 20 may be used to select, compose, and/or modify an outgoing message which will be communicated with the one or more users 26, for example, in the event of a natural disaster or terrorist act.

The DENIS system 20 and the message server 22 are also configured to receive active confirmation 30 from at least one of the users 26 that the outgoing message was received. The active confirmation 30 is an action that the user 26 takes to confirm the receipt of the message and can vary depending on the communication method used to deliver the outgoing message, whether or not the user 26 received the outgoing message at the time of delivery, and whether or not the user needs or wants to use a different communication method to actively confirm receipt of the outgoing message. Examples of ways a user 26 may actively confirm an outgoing message include, but are not limited to:
clicking on a web link in an email or an instant message;
clicking on a button in an email or an instant message;
visiting a web address specified in a voice, fax, broadcast, or other communication;
entering a code at a website;
entering a code during an alert phone call;
entering a code during a phone call which follows receipt of the outgoing message;
speaking a confirmation during an alert phone call;
speaking a confirmation during a phone call which follows receipt of the outgoing message;
sending an instant message in reply to an outgoing message;
sending a text message in reply to an outgoing message; and
making a phone call to a designated phone number following the outgoing message.

The DENIS system 20 can track the statistics of how many and which users have actively confirmed receipt of the outgoing message. This provides more useful information to administrators and authorized users of the DENIS system than automatically generated confirmation of delivery from a user device since there is an important difference between a message reaching an email inbox, a voicemail box, a text message inbox, or otherwise stored or displayed on a user device and a user actually reading, understanding, and processing the outgoing message. The active confirmation process lets the DENIS system 20 know that the user has read or heard, processed, and understood the outgoing message.

The DENIS system 20 also has a computing system 32 which may be configured to use the active confirmation 30 received by the message server 22 to connect the at least one user to a group communication environment 34. Examples of a group communication environment include, but are not limited to, a blog, a wiki, a teleconference, an online chat room, an instant message conversation, a video conference, and an online meeting. The DENIS system 20 can be configured so that only some users 26 who receive an outgoing message are able to be connected to the group communication environment 34. The connection of the user 26 to the group communication environment 34 can be facilitated by the following non-limiting methods in response to an active confirmation:
providing the user with a web link to a blog;
redirecting the at least one user to the blog;
providing the at least one user with a web link to a wiki;
redirecting the at least one user to the wiki;
transferring the at least one user to a teleconference;
providing the at least one user with a call-in phone number for the teleconference;
calling the at least one user and transferring the at least one user to the teleconference;
providing the at least one user with a link to an online chat room;
redirecting the at least one user to the online chat room;
sending the at least one user an instant message allowing them to join an instant message conversation;
transferring the at least one user to a video conference;
providing the at least one user with a link to the video conference;
transferring the at least one user to an online meeting; and
providing the at least one user with a link to the online meeting.

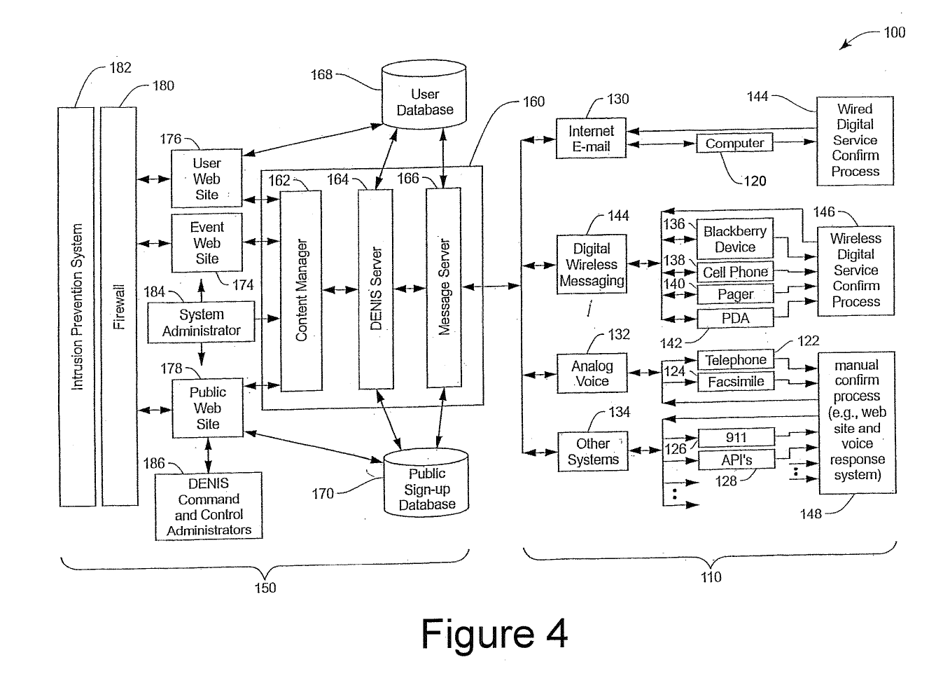

In this manner, target users can be quickly linked and able to communicate with each other. In group communication environments 34 which are internet-based, or LAN or WAN based, the users who join the group communication environment will be able to post attachments such as videos and pictures for others in the group communication environment to see in addition to being able to type, speak, and/or see each other. As will be described in more detail with regard to FIGS. 4-7, the DENIS system may also be configured to collect data from a variety of sources, including the public. This collected data can be shared with the users in the group communication environment.

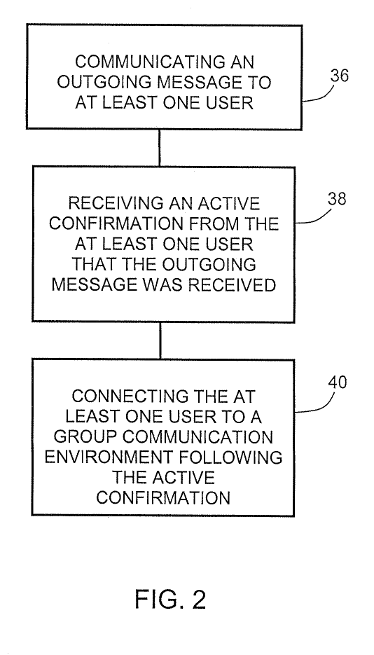

FIG. 2 illustrates one embodiment of a method of providing and gathering real-time information to and from at least one user by enabling them to communicate within a group communication environment. First, an outgoing message is communicated 36 to at least one user. This can be accomplished via a variety of methods, including email, voice, voicemail, text-to-speech, voice-over-IP (VoIP), instant message, text message, broadcast, and fax. Next, as a result of some action from the user, an active confirmation is received 38 from the at least one user that the outgoing message was received. Examples of different methods of actively confirming a message have been discussed above. Finally, the at least one user is connected 40 to a group communication environment following the active confirmation. This connection to the group communication environment may be facilitated or enabled by the computing system 32 of the DENIS system 20 as a follow-on action to the active confirmation.

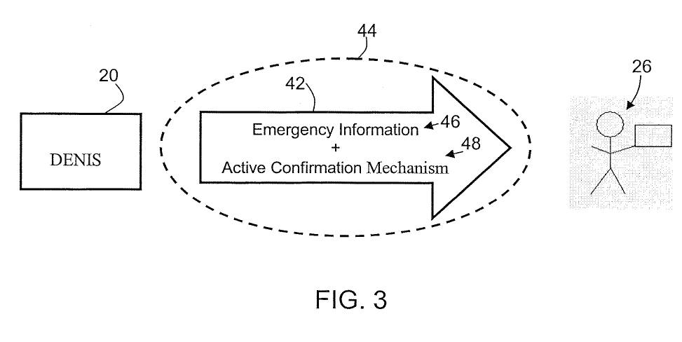

FIG. 3 schematically illustrates an embodiment of a data signal 42 for transmission over a physical medium 44 as a key part of the communications between a DENIS system 20 and a user 26. The data signal 42 includes emergency information 46 and an active confirmation mechanism 48. The active confirmation mechanism 48 may be a phone number to call, a web link to enter or click, instructions to repeat or enter a code, or other similar instructions.

FIG. 4 schematically illustrates some of the functionality and structure for one embodiment of a DENIS system 100 which may be used to implement the methods described above. The DENIS system 100 enables mass bi-directional emergency communication with active confirmation, data collection, and real-time cooperative tools. DENIS system 100 is configured to communicate over a plurality of communication channels 110 and may communicate with a wide variety of user communication devices/interfaces such as, but not limited to, a computer 120, a telephone 122, a facsimile machine 124, 911 connections 126, an application protocol interface 128 (API 128), a Blackberry® device 136, a mobile phone 138, a digital pager 140, a PDA 142, and a short wave radio (not shown). A variety of communication methods and protocols may be used for the communication channels 110, such as, for example, email 130, digital wireless messaging 144, analog voice 132, and voice-over-IP (VoIP). It should be apparent that other embodiments may include other protocols, communication methods, and communication devices. Those skilled in the art will see that such other protocols, communication methods, and communication devices will fit into, and are intended to be included within the scope of, the DENIS system 100 which is disclosed herein and its equivalents.

The active confirmation capabilities of the DENIS system 100 are facilitated by human confirmation returned using a variety of processes, for example, but not limited to, a wired digital confirmation process 144, a wireless digital confirmation process 146, and a manual conformation process (e.g., web site and voice response system) 148.

The DENIS system 100 has one or more command center nodes 150, each operating in a secure, client-server network configuration, wherein the command center node 150 includes a computing system 160 having a content manager 162, a DENIS server 164, and a message server 166 for storing at least one notification list. A notification list is a series of database records wherein names and other contact information are recorded. It will be appreciated that the creation and organization of such a list may include, in the present embodiment, information such as: Name: First & Last, Contact Method: Primary Email, Primary Email Address, Secondary Email Address, Address 1, Address 2, City, State/Province, Zip/Postal Code, Country, Title, Company, Home Phone, Work Phone, Cell Phone, Cell Phone Email, Alphanumeric Pager, Alphanumeric Pager Email, Fax, and additional information segments which have been customized for appropriate contacts.

DENIS system 100 may have various features and functions associated with the automatic, dynamic, and/or manual management of notification list(s). More specifically, the DENIS system 100 may include list management technology for performing one or more of the following:
dynamically creating new lists;
filtering or similar processing of lists, including functions to automatically remove lists or members of lists, remove or verify duplicate contacts; and/or
the use of set theory in the management (e.g., merger) of existing lists. For example, use of email to create communication to built-up notification list(s).

For such lists the technology allows the organization to distribute online information cheaply and effectively, building in ways to assure messages are read and the identity of the reader. The technology also enables the software creation of templates or “surveys” in HTML in the computing system 160 for bringing in information from the entities on the notification list which would be critical information in various kinds of emergencies. As described herein, the system also enables the management of lists and communications directly from a browser interface connected to the event web site 174, the user web site 176, and/or the public web site 178 in the command center node 150.

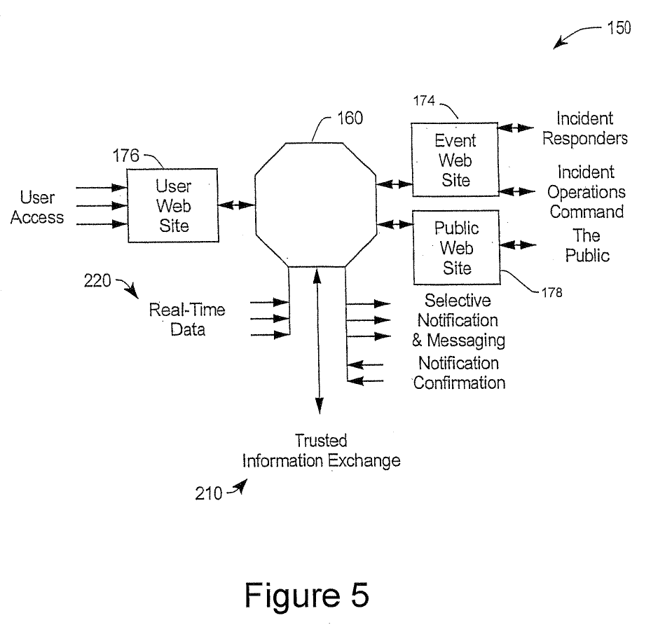

The command center node 150 also includes one or more data storage devices such as a magnetic disk or similar memory and mass storage devices including a user database 168, and a public sign-up database 170. In this embodiment, the event web site 174, user web site 176, and public web site 178 connect to the internet through a firewall 180 and an intrusion prevention system 182. There are two operational blocks which have direct human control: a system administrator block 184 for site administration and a DENIS command and control administrators block 186 for receiving and entering public non-emergency information into the system and for receiving and sending trusted information with other DENIS command center nodes 150 and other emergency agencies through a trusted information exchange network 210 shown in FIGS. 5, 6 and 7.

As will be appreciated, the plurality of communication channels 110 transmits information to and may receive at least an acknowledgement from the hard-wired communication devices and wireless communication devices, wherein at least one communication channel, and specifics for the contact (e.g., telephone number, e-mail address) are stored in the notification list for each recipient. The system preferably provides for continuing message transmissions to an array of personal devices until an active confirmation or acknowledgement is received as has been discussed above with regard to FIGS. 1-3. An auto-resend feature can be set for any time interval and can roll through channels/devices as the recipient desires (coded via the notification list data) or as the situation dictates (e.g., dependent upon emergency or security level). The system stores predefined messages and distribution lists, and provides easy-to-use tools to rapidly create custom messages or distribution lists that can be launched on a moment's notice.

Using an intuitive web-based tool, message recipients can manage their own communication preferences via the user web site 176. They can specify device priorities and maintain their e-mail, cell phone, PDA, pager, telephone, and facsimile numbers and addresses. Active confirmation of message receipt/reading is easily accomplished with digital systems through one-click options. Active confirmation of analog messages may be accomplished through a return call to an automated system or through a digital alternative. The DENIS command center node 150 databases also provide a real-time record of messages sent and active confirmations received, as well as other event information.

The DENIS server 164 includes an intelligence module with real time data aggregation, providing a powerful tool to help optimize timely and effective response to events. The module can be broadly deployed across the Internet through the web sites 174, 176, and 178 in situations where real-time incident information and data aggregation are needed for command and control purposes.

An example of the application of the actionable intelligence feature is the gathering and distribution of real time data, shown as connections 220 in FIGS. 5, 6, and 7, from reporting users via the web sites 174, 176, and 178 for example on emergency room and medical center activities to identify certain types of cases, such as Anthrax, smallpox, or other conditions related to bio/chemical events. The DENIS system 100 has the capability to dynamically allow the creation of distribution lists and intelligence requests for any type of emergency. It also facilitates the collection of information through the public web site 178 (e.g., observers of international waterways such as Great Lakes can log in suspicious boats, landings at non-port locations, etc.). Hence, the system may include means for the collection of real-time data 220 (e.g., border observers, police, fire, medical and other emergency services workers).

As is further illustrated in FIG. 4, the DENIS system 100 includes the event web site 174 where recipients of a communication may log in to review, input, or receive additional information. The event web site 174 is used for event-specific information. After notification occurs, first responders and others may go to the event web site 174 and gain encrypted access to detailed event information or provide additional information. Information can be text, audio, pictures, or video, depending on the available bandwidth and devices in use. Another function of the site is to manage survey or surveillance information. The event web site 174 is a closed system not intended for public use.

An application example is the ability to accompany a terrorist alert regarding a specific threat (i.e. the intent to steal tank trucks containing chemicals) with secure access to descriptions and photos of the size & correct tank shapes of the target vehicles and/or suspect descriptions. The event web site 174 also provides for surveys of investigators, potential target companies, etc. and real time data aggregation.

The public can access the command center node 150 to receive information through the public web site 178. The Public Web Site 178 is for bi-directional information sharing—to share information with the public and a means for the public to provide information to the DENIS Command and Control administrators 186 (e.g., via prompted surveys, reporting templates, etc.). The site can include the capability for the public to sign up to receive alerts.

It will be further appreciated that all or certain portions of the command center node 150 may include a secure user interface through which users of the system are able to access the system and modify notification lists, initiate emergency communications, etc. Such a feature is enabled via a user web site 176, which is protected by the firewall 180 and intrusion prevention system 182. As will be appreciated from FIG. 4, security may be achieved through several methods, including:
Firewall 180: To provide protection of all DENIS system components;
Intrusion Prevention System 182: To fend off Distributed Denial of Service and other attacks;
Redundant/Distributed Data Center Locations: To provide backup in case one site goes down or is inaccessible;
User Authentication: To control access to the DENIS tools and information;
Encryption: To protect information and messages in transit; and
Virus Protection: To protect from Internet viruses.

The DENIS system 100 may be an encrypted information system using a Trusted Information Exchange (TIE) channel 210 as depicted in FIGS. 5-7, a unique feature utilizing Hyperspace Communication's proprietary Secure Transport Service (STS) application, to provide private, highly secure, and United States Postal Service (USPS) certified two-way information exchange over the Internet. Information exchange is process and data format independent, and is protected both in transit and at rest; from application to application; individual to individual; and point of origin to point of process. In TIE private data exchange, and sender-receiver authentication is provided through digital certificate validation. Every exchange is certified using the Hypership Digital Receipts that can be postmarked by the United States Postal Service with the Electronic Postmark (EPM), bringing the added strength of postal law to each transaction.

STS is the result of collaboration with the General Services Administration (GSA), the Social Security Administration (SSA), and the USPS. Hyperspace built STS based on Hypership technology. SSA has implemented STS across constituent Federal, State and local agencies to exchange mission critical data for five production applications. STS has proven to be rapidly deployable, as well as supportable at all levels of government to enable a unified solution for trusted cross-agency secure information sharing. TIE may be comprised of leading-edge commercial components: GSA's ACES Digital Certificates and centralized ACES certificate validation (e-Authentication), the USPS's Electronic Postmark (EPM), and the advanced Hypership transport technology provided by Hyperspace.

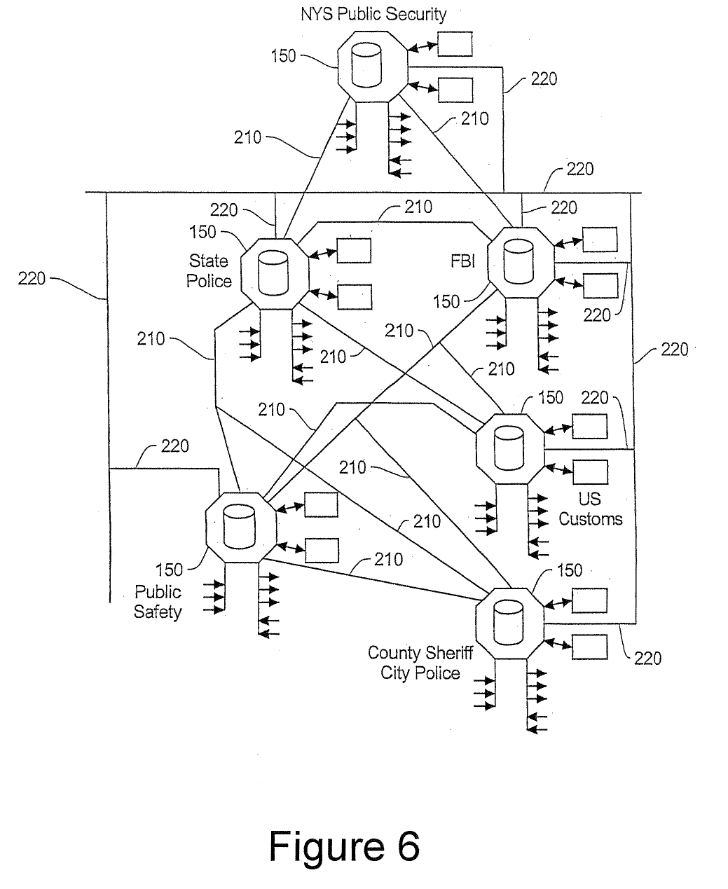

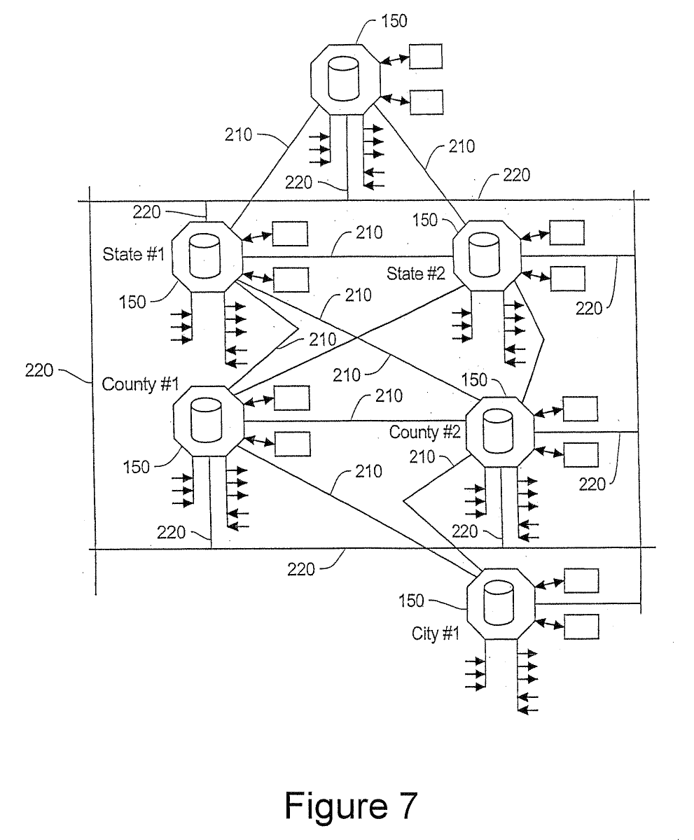

Turning briefly to FIGS. 6 and 7, the figures depict exemplary illustrations of multi-node systems for large-scale DENIS systems. As illustrated, each of the implementations depicted utilizes a plurality of DENIS system nodes 150. The nodes are interconnected via established logical relationships on one hand and by TIE channels 210 or similar communications channel technology on the other hand. Hence, this embodiment is intended to facilitate a communication link or channel to a similar system operated by another agency. More importantly, as described above, the inter-agency or inter-DENIS node communications would preferably be encrypted.

As will be appreciated, each node, and possible inter-nodal communications would provide the means described above for tracking the receipt of active confirmations from recipients on the notification list and in the event of no active confirmation from a particular recipient, resending the information through an alternate communication channel, (automatic re-notification, may be multiple-device notification or rolling, one device to another until active confirmation is received). Moreover, the nodes may communicate with one another to facilitate sharing, coordination and linking of notification lists which may also be composed dynamically, from preexisting database, based upon the type of information to be communicated (e.g., notification is to police, Coast Guard, and Border Patrol when observer reports boat landing along shoreline at non-port area, whereas a report of a nuclear emergency at a power plant results in the notification of public and all emergency services providers).

In one embodiment, a system for voice communication with an optional teleconference, which is automatically initiated, is implemented. The optional teleconference is an example of a group communication environment which was discussed previously. A voice message is generated and sent to designated recipients via telephones. The telephones can include traditional telephones, cell phones, satellite phones, and VoIP devices. An Internet database may be provided that contains necessary contact information of individual recipients. The database can be organized into lists or groups and only individuals in selected groups or lists receive the voice message. Lists or groups can be predefined or, alternately, filtered in real-time by an administrator to meet unforeseen situations. After each recipient receives the voice message, in response to a prompt, he or she provides an active response back in real-time to acknowledge receipt of the message via speaking into the telephone or touching a sequence of keys on the receiving telephone keypad, for example.

The received voice message can provide instructions for actions to be taken during an emergency situation. In addition, the message can instruct the caller to remain on the open telephone line for a live real-time conference call. The system then will automatically connect all the confirmed users of the list or group together in real-time, preferably without bridges or conference codes. One or more lists can be selected to receive the message only, while other lists can be selected to be automatically connected to other parties after the active confirmation of the receipt of the message.

This embodiment preferably is implemented using an application service provider model. The message and conference call can be initiated from administration capability at a command and control point with an Internet user interface. Additionally, calls can be initiated from remote locations with Internet access and lists or groups can also be accessed anywhere via IVR from telephones or by handheld devices using email or SMS. Messages and initiation of conference calls can be scheduled to occur at a specific time or initiated after a specific time period. Preferably, the database is protected with security controls such as those known in the art.

This embodiment preferably is designed around the use of Interactive Voice Response Systems (IVR) using Voice XML and CCXML as enabling technologies and standards. Using the desired lists or groups, the system generates an outbound call request for each recipient. Each outbound call request is passed to the CCXML portion of the system, which places the call and manages the interaction with the recipient. Additionally, VoiceXML is used in the delivery of the message content and the processing of the recipient response(s). All message delivery status information, receipt confirmation, and other information is immediately passed back to the system and logged in the database.

This embodiment was initially designed for first responders in emergency situations. However, the same capabilities could be used for a number of other non-emergency situations as well.

In some embodiments, when a conference call is taking place, either initiated as described above or otherwise, an authorized individual can enter the conference call by logging into a web site and/or clicking a button. Then, either a pre-defined phone number or one specified at the time would be automatically dialed. Then, preferably, after appropriate verification, the authorized individual would enter the conference call.

Similarly, in some embodiments, when a text-based chat is taking place, e.g. instant messaging, authorized individuals can participate in the chat by logging into a web site and clicking a button, using an instant messaging application or connecting to the chat via a cell phone or other hand-held device. Then, preferably, after appropriate verification, the authorized individual would be able to read and participate in the text-based chat. In some embodiments, if all participants in the text-based chat agree, a participant in the text-based chat can convert the text-based chat into a voice chat. The converted voice chat would take place over the same devices, e.g. computers, that the participants were using to participate in the text-based chat.

In some embodiments, chat sessions are created automatically whenever a notification or alert is sent.

In other embodiments, a blog or a wiki may be created automatically whenever a notification or alert is sent.

Some features included in or enabled by a DENIS system are:
Inter-Agency Communication—DENIS provides emergency information across agencies, jurisdictions, and other geopolitical boundaries, solving many of today's interoperability problems.
Hosted Service—DENIS is provided over the Internet as a service for a low monthly fee. All infrastructure, hardware and software, is provided—customers have no need for expensive IT personnel or support services. Because of this approach, DENIS can be quickly deployed. It will be appreciated that DENIS may also be licensed or distributed in through alternative means or channels.
Integrates with existing 911 centers
Distributed Node Architecture—DENIS is highly configurable to all situations and user requirements.
Supported Devices—DENIS supports a wide array of digital and analog communication devices.
Cell Phones will receive and send text and voice message.
PDAs will receive text email messages.
Blackberry email devices will receive text email messages.
Telephone (POTS)—A text message will be converted automatically to speech and then transmitted via Voice over IP (VoIP) through the analog telephone systems.
Facsimile messages will be sent to machines by automatically converting the test message to a faxable format.
Short Wave Radio messages will be sent via e-mail to the radio dispatcher for subsequent transmission over the radio.
Notification & Receipt Confirmation—DENIS provides for continuing message transmission until message confirmation is received or some other criteria is met. The auto-resend feature can be set for any time interval and can roll through devices based on the recipient's established preferences or as the situation dictates.
E-mail Messages in both text and HTML can be embellished using graphics, sound, and/or video.
Message Priority levels are defined by the user. The priority level selected invokes different message transmittal procedures.
Active Message Confirmation is the process that follows the sending of a message that documents receipt of the message. There are different methods of active confirmation, determined by the device type receiving the message and sender priority. Confirmations are tracked by individual. Confirmation is accomplished with digital devices through simple options. Analog message confirmation is accomplished through a return call to an automated system or through a digital alternative.
Dynamic List Creation—DENIS provides predefined lists of contacts organized by departments and types of incidents. DENIS list creation tools enable real-time generation of emergency notification lists for any situation.
Contact Information Personalization allows subscribers access to their individual records to update contact information.
Actionable Intelligence—With real-time data aggregation, DENIS provides for powerful tools to help optimize timely and effective response to events. This unique DENIS capability enables use of state-of-the-art tools to analyze information about incidents and data collected through Survey.
Survey provides DENIS customers with very simple tools to create questionnaires and other types of information gathering/distribution packages.
Report Manager is a set of tools that facilitates management and interpretation of incident information. Statistical analysis tools through Excel and other software can be used to analyze data.
Private & Public Communication—Three web sites provide communication functionality. The Public Web site is for bidirectional information sharing—to share information with the public and a means for the public to provide information to the DENIS Command and Control personnel. The Event Web Site is a non-public site for collecting and sharing incident related information. The User Web Site is primarily focused on administrative functions.
Event Web Site is focused on communications and information dealing with incidents. After notification occurs, first responders and others may go to the Event Web Site and gain encrypted access to detailed incident information. Real-time information from the incident, about the incident, and for incident responders/managers is available at this web site. A content management system is utilized to manage information. The Event Web Site is a closed system not intended for public use.
User Web Site is specific to individual customers. Primary functions include access for subscribers to change personal contact information, communications of internal information, collection of internal information, and to initiate surveillance activities. The User Web Site is a closed system not intended for public use.
Public Web Site is an integrated component where the public can sign-up to receive information and announcements, and to share information with the public. The public can also send information to the DENIS Command and Control personnel.
Interfaces To Other Systems—Internet links can be established to existing web sites and databases.
System Availability—No option can guarantee 100% uptime, but the probability of the Internet going down is significantly less than local intranets and other systems fully dependent on local resources. Some embodiments of DENIS systems will have redundant servers located at data-centers across the country to ensure maximum availability. In some embodiments, satellite linkage will be available for Internet access in areas without wireless access or when normal access modes fail.
System Security—System security is extremely important and may be accomplished through several methods.
   Firewall: To provide protection for all DENIS system components.
   Intrusion Prevention System: To fend off Distributed Denial of Service and other attacks.
   Redundant/Distributed Data Center Locations: To provide backup in case one site goes down or is inaccessible.
   User Authentication: To control access to the DENIS tools and information. Different levels of security are available based on customer needs.
   Encryption: To protect information in transit.
Incident Reporting
Incident Facts—Another unique DENIS module provides a complete history of an incident. This record includes notification history, all messages transmitted through the DENIS, all information placed on the Event Web Site and Public Web Site. IncidentFacts CD/DVD's may be provided to customers for their use.
Actionable Intelligence—DENIS' unique Survey capability and analytical tools may be upgradeable based on user feedback.
Report Manager tools may be expandable based on customer needs. These tools may be used to organize lead information provided by investigators and public sources.
InfoMine—This unique analytical DENIS module will provide state-of-the-art tools to analyze information about incidents and data collected through Survey. Tools include analysis of static databases and of streaming data—real time review of information as it arrives. These tools can be utilized to track performance or to detect out-of the-ordinary occurrences.
Digital Photo Management
Video Management
Geographic Information Systems
In some embodiments, users may be able to geographically select areas for large-scale notifications in the event of an emergency.
Interfaces To Other Systems—Application Programming Interfaces (API's) may be established to link to additional databases.
Private & Public Communication—The functionality of the Event Web Site may be expanded as digital capability and bandwidth availability expands.

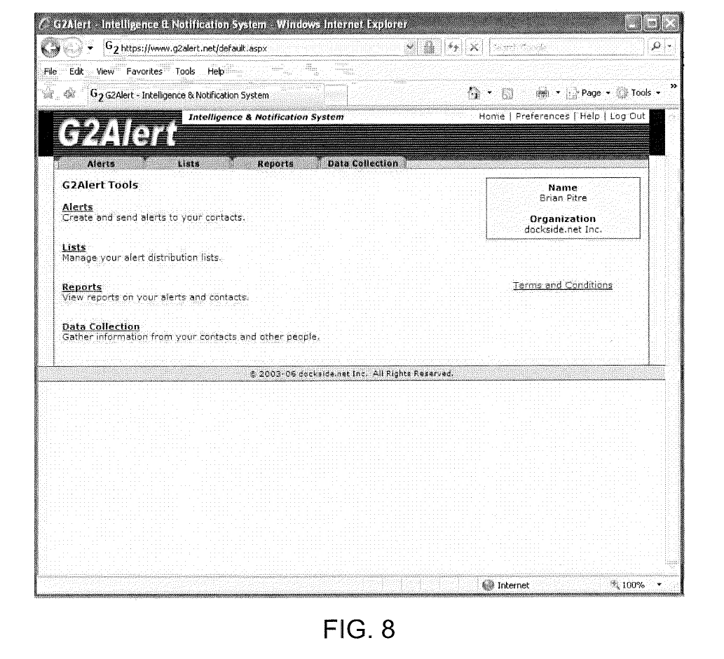

FIGS. 8-15 illustrate embodiments of possible DENIS system user interfaces to provide an understanding of just some of the administrative and user capabilities which are enabled by the DENIS system and to provide context for the systems, features, and methods described above. FIG. 8 illustrates one embodiment of a DENIS system user interface for managing alerts, lists, reports, and data collection. This is an example of a possible starting point for an authorized user of the DENIS system. Lists may be created and maintained of various contacts. Alerts can be sent to one or more contacts or one or more lists of contacts. Reports relating information on the sending and active receipt confirmation of alerts may be viewed. Tools are also provided for gathering data from the contacts and the other people such as the public.

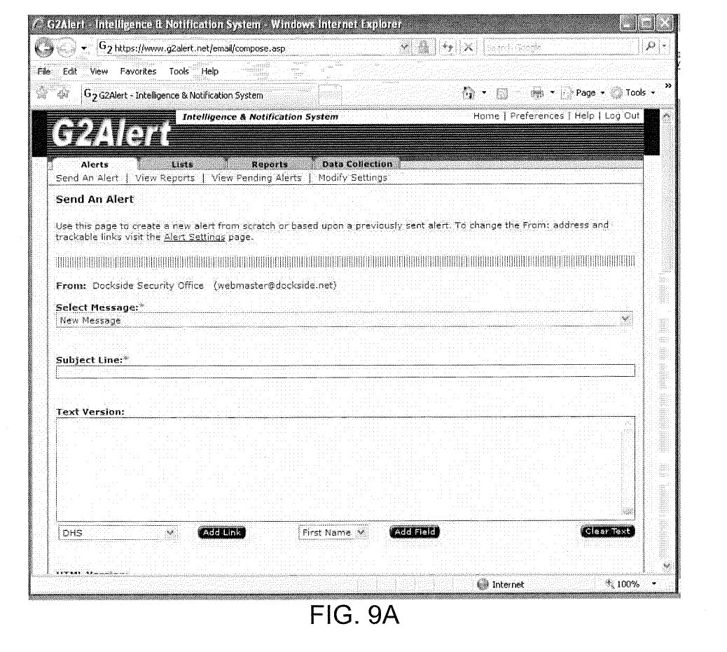

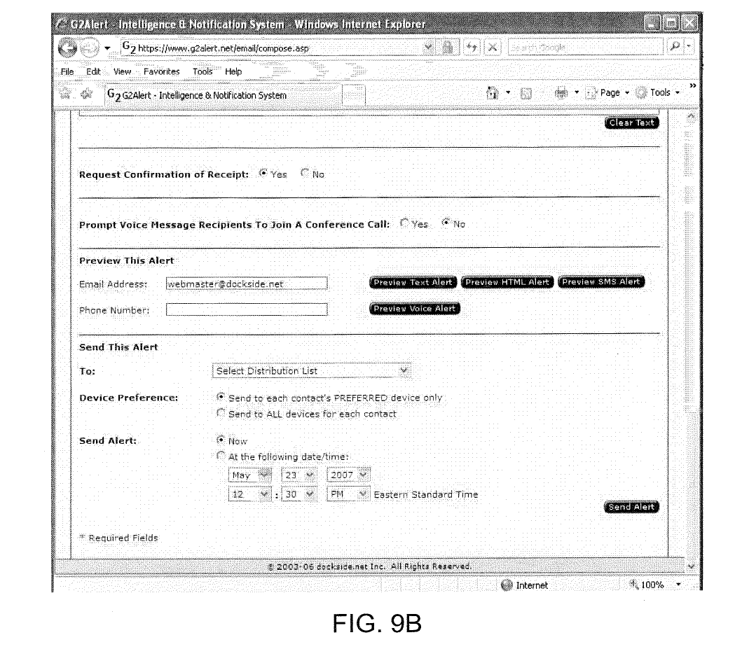

FIGS. 9A and 9B illustrate one embodiment of a DENIS system user interface for sending an alert. New alerts can be created from scratch using the blank form provided or based on a previously sent alert which can populate the form as a starting point. Since the message may be communicated in a variety of ways to a variety of devices, the alert may be entered in a variety of ways, including text, HTML, and SMS. A text-to-speech engine is provided to convert the text into an audible message for phone calls. All versions of the message may be previewed and edited. Lists for distribution of the alert may be selected as well as which types of devices to send to. The delivery time for the alert may also be selected. Selection buttons are provided to request active confirmation of receipt of the message as well as whether or not to enable the recipient to join a conference call. In other embodiments, there may be choices to allow the user to join a video conference, a net meeting, an online chat, an instant message conversation, a blog, and/or a wiki.

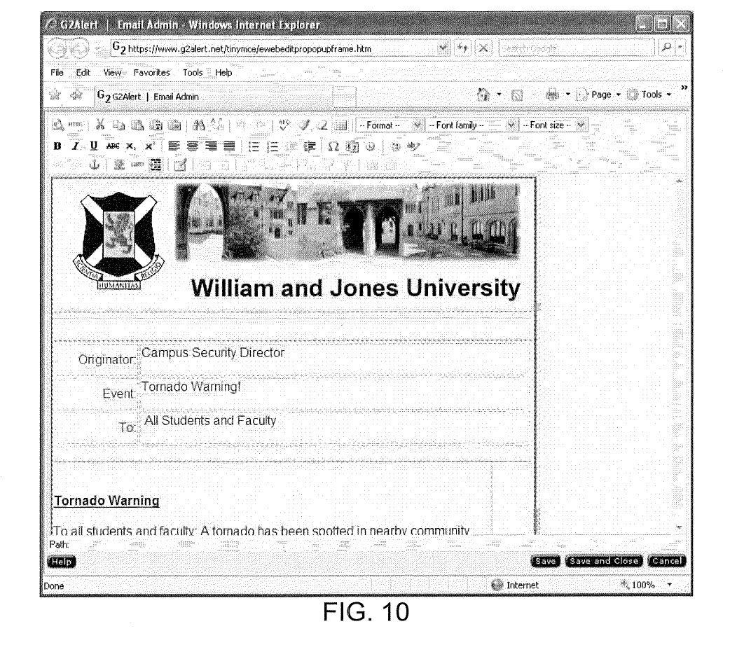

As mentioned with regard to FIGS. 9A and 9B, the user can preview and edit different versions of the alert. FIG. 10 illustrates one embodiment of a DENIS system user interface for previewing and editing an HTML version of an alert. Familiar document editing controls may be provided to reduce the learning curve for the system.

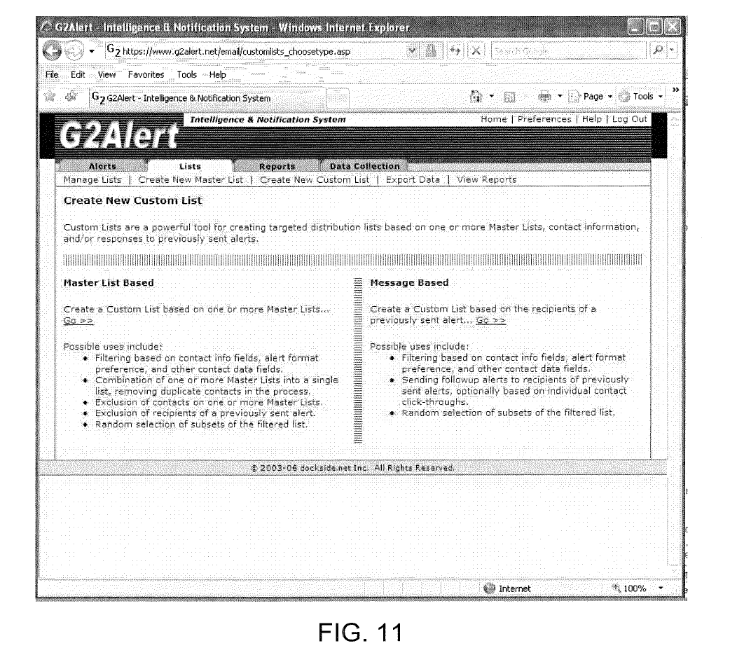

FIG. 11 illustrates one embodiment of a DENIS system user interface for managing user lists. Master lists may be created. Custom lists may also be created based on subsets and/or combinations of master list entries as well as based on recipients of a previously sent alert.

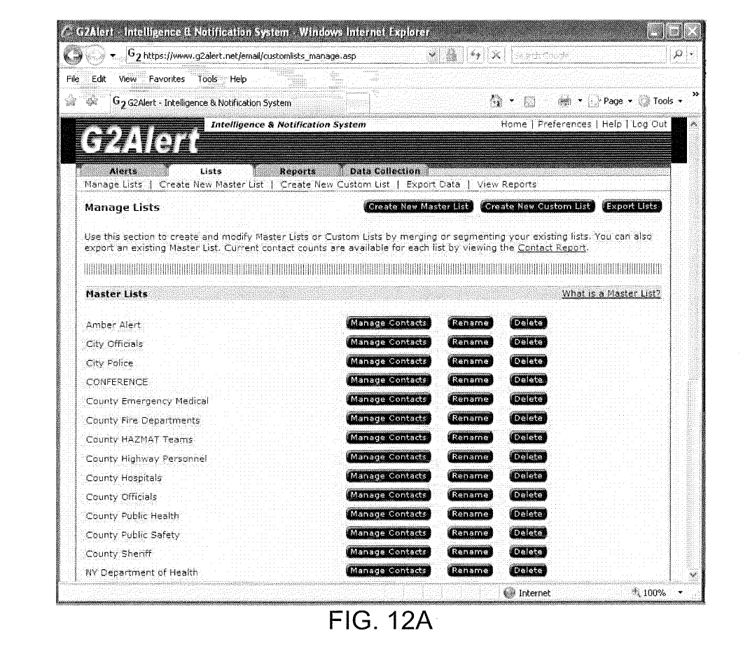

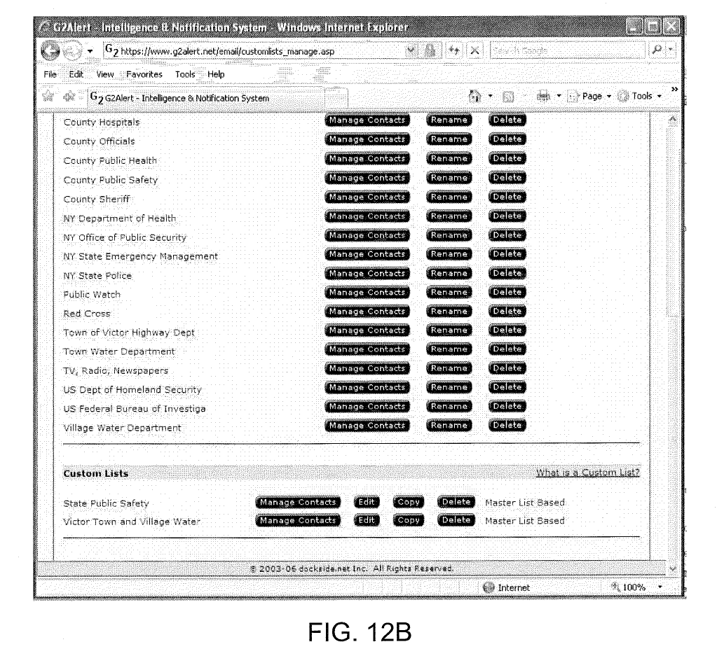

FIGS. 12A and 12B illustrate another embodiment of a DENIS system user interface for managing user lists.

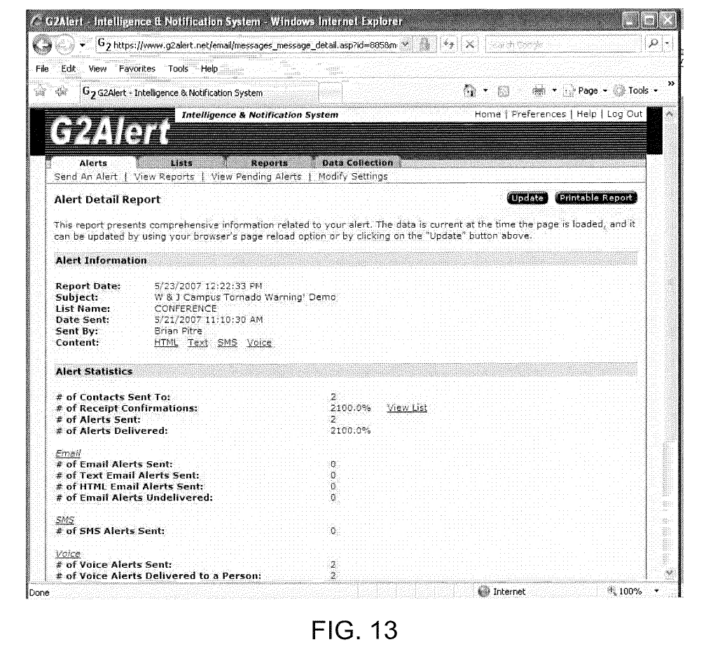

FIG. 13 illustrates one embodiment of a DENIS system user interface for viewing active confirmation details for an alert. Such a report may be useful in determining the effectiveness of an alert and whether or not there is a need for a follow-up alert. The report may also be helpful for audit purposes to document the type of notifications which were sent for a particular incident.

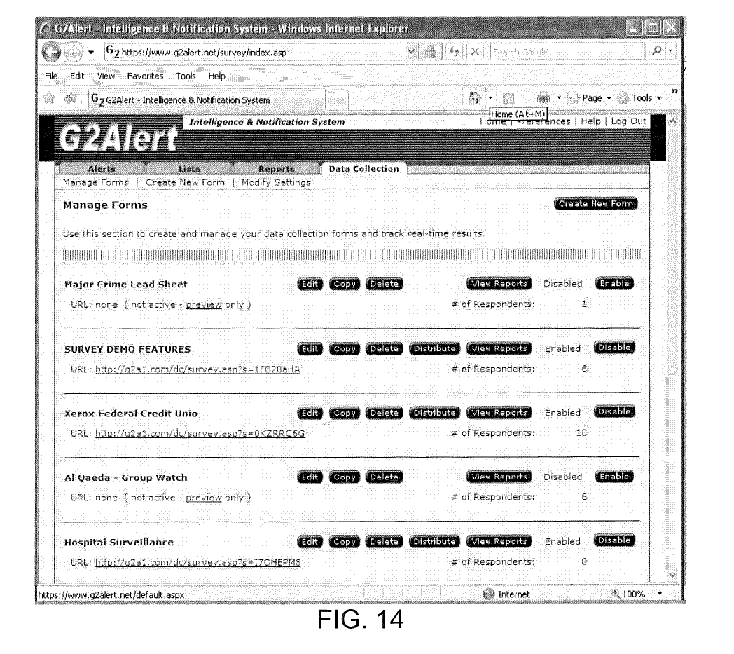

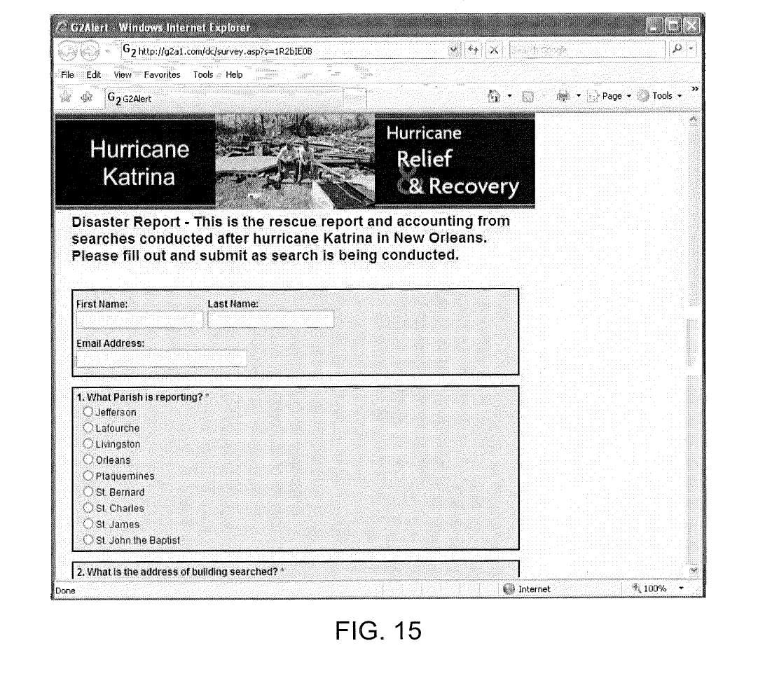

FIG. 14 illustrates one embodiment of a DENIS system user interface for managing data collection forms. Forms can be created, edited, and re-used. An example of part of a data entry form created by a user of the DENIS system is shown in FIG. 15.

Various advantages of the claimed invention have been described. The claimed invention is also advantageous because it is efficient and more reliable when compared to other approaches for emergency notification, and it works across many communications channels and technologies. Aspects of the claimed invention enable it to be adapted to any of a number of situations and also facilitate the use of the system to collect, compile, analyze and report information in manner that may be advantageous to applications such as security, law enforcement, medical emergencies, and responses to act of nature and terrorism. As a result of the claimed invention, information may be instantly delivered, via an electronic interface, to multiple types of communications devices, delivering the right data to the right people at the right time with active confirmation and the ability to connect people in a group communication environment.

Having thus described several embodiments of a DENIS system and its related components, features, and methods, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of the processing elements or sequences, or the use of numbers, letters, or other designations therefore, is not intended to limit the claimed processes to any order except as may be specified in the claims. Accordingly, the claimed invention is limited only by the following claims and equivalents thereto.

What is claimed is:

1. A dynamic emergency notification and intelligence system (DENIS system), comprising:
a) a message server configured to:
i) communicate an outgoing message to a plurality of users via one or more user devices; and
ii) receive active confirmation from at least one user of the plurality of users that the outgoing message was received; and
b) a computing system configured to use the active confirmation received by the message server from the at least one user to connect the at least one user to a group communication environment.

2. The DENIS system of claim 1, wherein the message server is configured to communicate using a method selected from the group consisting of email, voicemail, analog voice communication, radio communication, text messaging, digital wireless messaging, voice-over-IP, broadcast message, paging, digital voice communication, instant messaging, and fax transmission.

3. The DENIS system of claim 1, wherein the one or more user devices are selected from the group consisting of computers, PDA's, mobile phones, Blackberry® devices, pagers, telephones, fax machines, 911 call centers, and application protocol interfaces (API's).

4. The DENIS system of claim 1, wherein active confirmation comprises confirmation that a web link included-in or referred-to by the outgoing message has been clicked by the at least one user.

5. The DENIS system of claim 1, wherein active confirmation comprises confirmation that a code has been entered by the at least one user on a website referred-to by the outgoing message.

6. The DENIS system of claim 1, wherein active confirmation comprises confirmation that a code has been entered by the at least one user during a phone call.

7. The DENIS system of claim 6, wherein the phone call comprises an alert call made from the message server to the at least one user to communicate the outgoing message.

8. The DENIS system of claim 6, wherein the phone call comprises a return call made from the at least one user to a phone number referred-to by the outgoing message.

9. The DENIS system of claim 8, wherein the message server is further configured to communicate the outgoing message by making an alert phone call to the plurality of users, and the phone number referred-to by the outgoing message is automatically appended to the outgoing message when the message server determines that the at least one user did not answer the alert phone call.

10. The DENIS system of claim 1, wherein active confirmation comprises confirmation that a code has been spoken by the at least one user during a phone call.

11. The DENIS system of claim 10, wherein the phone call comprises an alert call made from the message server to the at least one user to communicate the outgoing message.

12. The DENIS system of claim 10, wherein the phone call comprises a return call made from the at least one user to a phone number referred-to by the outgoing message.

13. The DENIS system of claim 12, wherein the message server is further configured to communicate the outgoing message by making an alert phone call to the plurality of users, and the phone number referred-to by the outgoing message is automatically appended to the outgoing message when the message server determines that the at least one user did not answer the alert phone call.

14. The DENIS system of claim 1, wherein active confirmation comprises confirmation that an instant message has been received from the at least one user.

15. The DENIS system of claim 1, wherein active confirmation comprises confirmation that a text message has been received from the at least one user.

16. The DENIS system of claim 1, wherein active confirmation comprises confirmation that a phone call has been received from the at least one user.

17. The DENIS system of claim 1, wherein the group communication environment is selected from the group consisting of a blog, a wiki, a teleconference, an online chat room, an instant message conversation, a video conference, and an online meeting.

18. The DENIS system of claim 1:
further comprising a user interface for collecting data related to the outgoing message; and
wherein the computing system is further configured to share the collected data with the at least one user in the group communication environment.

19. A method of providing and gathering real-time information to and from at least one user, comprising:
communicating an outgoing message to the at least one user;
receiving active confirmation from the at least one user that the outgoing message was received; and
connecting the at least one user to a group communication environment following receipt of the active confirmation.

20. The method of claim 19, wherein communicating an outgoing message to the at least one user is selected from the group consisting of:
emailing the at least one user;
calling the at least one user;
leaving a voicemail for the at least one user;
broadcasting to the at least one user;
text-messaging the at least one user;
sending a digital wireless message to the at least one user;
sending a voice-over-IP (VoIP) communication to the at least one user;
paging the at least one user;
instant messaging the at least one user; and
faxing the at least one user.

21. The method of claim 19, wherein receiving active confirmation from the at least one user that the outgoing message was received comprises receiving confirmation that a web link included-in or referred-to by the outgoing message has been clicked by the at least one user.

22. The method of claim 19, wherein receiving active confirmation from the at least one user that the outgoing message was received comprises receiving confirmation that a code has been entered by the at least one user on a website referred-to by the outgoing message.

23. The method of claim 19, wherein receiving active confirmation from the at least one user that the outgoing message was received comprises receiving confirmation that a code has been entered by the at least one user during a phone call.

24. The method of claim 23, wherein the phone call comprises an alert call made from a message server to the at least one user to communicate the outgoing message.

25. The method of claim 23, wherein the phone call comprises a return call made from the at least one user to a phone number referred-to by the outgoing message.

26. The method of claim 19 wherein receiving active confirmation from the at least one user that the outgoing message was received comprises receiving confirmation that a code has been spoken by the at least one user during a phone call.

27. The method of claim 26, wherein the phone call comprises an alert call made from a message server to the at least one user to communicate the outgoing message.

28. The method of claim 26, wherein the phone call comprises a return call made from the at least one user to a phone number referred-to by the outgoing message.

29. The method of claim 19 wherein receiving active confirmation from the at least one user that the outgoing message was received comprises receiving confirmation that an instant message has been received from the at least one user.

30. The method of claim 19 wherein receiving active confirmation from the at least one user that the outgoing message was received comprises receiving confirmation that a text message has been received from the at least one user.

31. The method of claim 19 wherein receiving active confirmation from the at least one user that the outgoing message was received comprises receiving confirmation that a phone call has been received from the at least one user.

32. The method of claim 19, wherein connecting the at least one user to the group communication environment following receipt of the active confirmation is selected from the group consisting of:
providing the at least one user with a web-link to a blog;
redirecting the at least one user to the blog;
providing the at least one user with a web-link to a wiki;
redirecting the at least one user to the wiki;
transferring the at least one user to a teleconference;
providing the at least one user with a call-in phone number for the teleconference;
calling the at least one user and transferring the at least one user to the teleconference;
providing the at least one user with a link to an online chat room;
redirecting the at least one user to the online chat room;
sending the at least one user an instant message allowing them to join an instant message conversation;
transferring the at least one user to a video conference;
providing the at least one user with a link to the video conference;
transferring the at least one user to an online meeting; and
providing the at least one user with a link to the online meeting.

33. The method of claim 19, further comprising collecting data from the at least one user.

34. The method of claim 33, further comprising sharing at least some of the date from the at least one user with other users in the group communication environment.

35. A data signal for transmission over a physical medium, comprising:
emergency information; and
an active confirmation mechanism.

36. The data signal of claim 35, wherein the physical medium is selected from the group consisting of one or more wires, the air, an RF link, an optical link, a satellite link, and a fiber optic link.

37. The data signal of claim 35, wherein the active confirmation mechanism is selected from the group consisting of:
hypertext markup language (HTML) instructions for displaying a weblink for a user receiving the data signal to follow;
HTML instructions for displaying a control for the user receiving the data signal to click;
instructions for automatically redirecting a web browser to a desired website;
audible instructions providing a user with a phone number to call;
audible instructions providing the user with a phone number to call and a code to enter;
audible instructions providing the user with a code to enter;
audible instructions asking the user to enter a code;
audible instructions asking the user to speak a code;
audible instructions providing the user with a web address to go to;
audible instructions providing the user with a web address to go to and a code to enter;
encoded instructions providing a user with a phone number to call;
encoded instructions providing the user with a phone number to call and a code to enter;
encoded instructions providing the user with a code to enter;
encoded instructions asking the user to enter a code;
encoded instructions asking the user to speak a code;
encoded instructions providing the user with a web address to go to;
encoded instructions providing the user with a web address to go to and a code to enter;
an invitation to join an online chat; and
an invitation to join an instant message conversation.

38. The data signal of claim 35, wherein the active confirmation mechanism is configured to enable a user to connect to a group communication environment.

39. The data signal of claim 38, wherein the group communication environment is selected from the group consisting of a blog, a wiki, a teleconference, an online chat room, an instant message conversation, a video conference, and an online meeting.
